(19) United States
(12) Patent Application Publication
(10) Pub. No.: US 2026/0168780 A1
(43) Pub. Date: Jun. 18, 2026

(54) Wearable Legwear System and Article for Detecting Foot Angles and Distances

(71) Applicant: Aayam Bansal, West Bengal (IN)

(72) Inventor: Aayam Bansal, West Bengal (IN)

(21) Appl. No.: 19/421,012

(22) Filed: Dec. 16, 2025

(30) Foreign Application Priority Data
Dec. 16, 2024 (IN) 202431099487

(51) Int. Cl. G01B 5/24; A41B 11/00; G01B 5/00; G01P 1/00; G01P 1/02; G01P 15/14

(52) U.S. Cl. CPC G01B 5/24; A41B 11/006; G01B 5/0004; G01P 1/023; G01P 1/06; G01P 15/14; A41B 2400/22; G01B 2210/58

(57) ABSTRACT

The present invention relates to sensor-integrated socks designed to measure and monitor foot angles and distances in real-time. Each sock is embedded with multiple sensors, including gyroscopes and accelerometers, strategically placed at the heel (S1), midfoot (S2), and optionally near the toes (S3). The sensors collect data on foot orientation and movement, which is transmitted wirelessly via a Bluetooth module to a mobile application. The application processes and displays the data, providing real-time feedback, historical data storage, and customizable alerts. The system includes a sports mode that adjusts thresholds based on physical activity, enhancing accuracy during static and/or dynamic movements. The socks are powered by a rechargeable battery and made from stretchy, breathable fabric for user comfort. This invention offers a non-invasive, cost-effective solution for managing foot conditions such as Metatarsus adductus.

### FIELD OF THE INVENTION

The present invention relates to wearable technology, specifically to a legwear article in the form of socks integrated with sensors for detecting foot angles and distances. The invention is designed to monitor and manage foot conditions such as Metatarsus adductus by providing real-time data on foot positioning. The socks are equipped with gyroscopes and accelerometers to measure foot angles in three dimensions and transmit the data wirelessly to an external processing unit for analysis and feedback.

### APPLICATION

The sensor-integrated socks are particularly useful for individuals at risk of developing foot deformities such as Metatarsus adductus, including young children, athletes, and those undergoing physical therapy. The invention provides a non-invasive, real-time monitoring solution that allows users to track their foot positioning and detect potential issues early. The socks are designed for comfort and prolonged wear, making them suitable for daily use. The data collected by the sensors can be transmitted to a mobile device, where a dedicated application processes and displays the information, providing users with actionable insights and alerts. The system can also support multiple user profiles, store historical data for trend analysis, and offer a sports mode to adjust thresholds based on physical activity.

### BACKGROUND OF THE INVENTION

Metatarsus adductus is a common foot deformity characterized by the inward turning of the front half of the foot. This condition often requires timely intervention to prevent complications and ensure proper foot development, particularly in young children. Traditional methods for monitoring and managing Metatarsus adductus typically involve specialist intervention and clinical visits, which can be inconvenient and costly for patients and their families. There is a need for a more accessible, user-friendly solution that allows individuals to self-monitor their foot positioning in real-time.

### Prior Art Problems

Existing solutions for monitoring foot positioning and detecting conditions like Metatarsus adductus have several limitations:
1. Specialist Intervention: Most current methods require regular visits to healthcare professionals, which can be time-consuming and expensive.
2. Lack of Real-Time Monitoring: Traditional approaches do not provide continuous, real-time data on foot positioning, making it difficult to detect and address issues promptly.
3. Inconvenience: The need for clinical settings and specialist equipment makes it challenging for users to monitor their foot health independently.
4. Limited Accessibility: Many existing solutions are not easily accessible to the general public, particularly in remote or underserved areas.

### Disadvantages of Prior Art

1. High Cost: Frequent specialist consultations and the use of clinical equipment can be financially burdensome for patients.
2. Inconvenience: The need to visit healthcare facilities for monitoring can be inconvenient and disruptive to daily life.
3. Delayed Detection: Without real-time monitoring, issues may go undetected until they become more severe, leading to delayed intervention and treatment.
4. Limited User Engagement: Traditional methods do not engage users in their own health monitoring, reducing the likelihood of consistent and proactive management.

### Technical Solution Proposed by the Present Invention

The present invention addresses these issues by providing a pair of sensor-integrated socks designed to measure foot angles and distances in real-time. The key components and features of the invention include:
1. Sensor Integration: Each sock is embedded with multiple sensors, including gyroscopes and accelerometers, strategically placed at the heel, midfoot, and optionally near the toes.
2. Data Transmission: The sensors are connected to a Bluetooth module, enabling wireless transmission of collected data to an external processing unit, such as a mobile device.
3. Rechargeable Power Source: A lightweight, flexible rechargeable battery powers the sensors and Bluetooth module, ensuring portability and user comfort.
4. Real-Time Monitoring: The external processing unit processes the data in real-time, providing users with immediate feedback on their foot positioning.
5. User-Friendly Application: A dedicated mobile application displays the collected data, generates alerts for abnormal foot angles or distances, and supports multiple user profiles and historical data storage.

### Technical Effect

The technical effect of the present invention includes:
1. Enhanced Accessibility: Users can monitor their foot positioning independently, without the need for frequent specialist visits.
2. Real-Time Data: Continuous, real-time monitoring allows for the early detection of potential issues, enabling timely intervention.
3. User Engagement: The mobile application engages users in their own health monitoring, promoting proactive management of foot conditions.
4. Cost-Effectiveness: By reducing the need for specialist consultations and clinical equipment, the invention offers a more affordable solution for managing foot health.

### Need for the Present Invention

There is a significant need for a more accessible, convenient, and cost-effective solution for monitoring and managing foot conditions like Metatarsus adductus. The present invention addresses this need by providing a wearable, real-time monitoring system that empowers users to take control of their foot health. The sensor-integrated socks offer a practical and user-friendly alternative to traditional methods, making it easier for individuals to detect and address foot positioning issues promptly. This innovation has the potential to improve outcomes for patients, reduce healthcare costs, and increase accessibility to foot health monitoring for a broader population

### OBJECT OF THE INVENTION

The primary object of the present invention is to provide a wearable legwear article, specifically a pair of sensor-integrated socks, designed to measure and monitor foot angles and distances in real-time. The invention aims to address the limitations of traditional methods for managing foot conditions such as Metatarsus adductus by offering a more accessible, user-friendly, and cost-effective solution. The specific objectives of the invention include:
1. Real-Time Monitoring: To provide continuous, real-time data on foot positioning, enabling early detection and intervention for foot deformities and other related conditions.
2. User Accessibility: To create a solution that allows individuals to self-monitor their foot health without the need for frequent specialist visits or clinical settings.
3. Comfort and Portability: To design the socks using stretchy, breathable fabric and lightweight, flexible components to ensure user comfort during prolonged wear.
4. Accurate Measurement: To integrate multiple sensors, including gyroscopes and accelerometers, strategically placed at the heel, midfoot, and optionally near the toes, for precise measurement of foot angles and distances.
5. Wireless Data Transmission: To incorporate a Bluetooth module for wireless transmission of collected data to an external processing unit, such as a mobile device, for analysis and feedback.
6. User Engagement: To develop a dedicated mobile application that processes and displays the collected data, generates alerts for abnormal foot angles or distances, and supports multiple user profiles and historical data storage.
7. Cost-Effectiveness: To offer a more affordable alternative to traditional methods by reducing the need for specialist consultations and clinical equipment.
8. Versatility: To provide additional features such as a sports mode that adjusts thresholds based on physical activity, and the ability to mute notifications during static and/or dynamic movements.

By achieving these objectives, the present invention aims to improve the management of foot health, particularly for individuals at risk of developing conditions like Metatarsus adductus, and to enhance the overall user experience through innovative, wearable technology.

### SUMMARY OF THE INVENTION

The following disclosure presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention relates to a wearable legwear article, specifically a pair of sensor-integrated socks, designed to measure and monitor foot angles and distances in real-time. The invention aims to provide an accessible, user-friendly, and cost-effective solution for managing foot conditions such as Metatarsus adductus. By integrating multiple sensors, a data transmission module, and a rechargeable power source into the socks, the invention enables continuous monitoring and early detection of potential foot deformities. The collected data is wirelessly transmitted to an external processing unit, such as a mobile device, where it is processed and displayed through a dedicated application.

### ASPECTS AND IMPLEMENTATIONS

### Sensor Integration

Sensors: The socks are embedded with multiple sensors, including gyroscopes and accelerometers, strategically placed at the heel, midfoot, and optionally near the toes.
Measurement: The sensors measure foot angles in three dimensions, including pitch, roll, and yaw, and detect the distance between the feet.

### Data Transmission

Bluetooth Module: The sensors are connected to a Bluetooth module, enabling wireless transmission of collected data to an external processing unit.
Real-Time Data: The data is transmitted in real-time, allowing for immediate feedback and monitoring.

### Power Source

Rechargeable Battery: A lightweight, flexible rechargeable battery powers the sensors and Bluetooth module, ensuring portability and user comfort.
Battery Placement: The battery is integrated into the socks in a manner that does not interfere with user comfort or sensor accuracy.

### External Processing Unit

Mobile Application: A dedicated mobile application processes and displays the collected data, providing users with real-time information on their foot positioning.
User Profiles: The application supports multiple user profiles, allowing different individuals to use the same system.
Historical Data: The application stores historical data for trend analysis and long-term monitoring.

### User Engagement

Alerts and Notifications: The application generates alerts when the measured foot angles or distances fall outside predefined thresholds, enabling early intervention.
Sports Mode: The application includes a sports mode that adjusts thresholds based on the selected physical activity and mutes notifications during static and/or dynamic movements.

### Comfort and Design

Fabric: The socks are made from stretchy, breathable fabric to ensure user comfort during prolonged wear.
Sensor Pockets: The sensors are integrated into pockets within the sock material to ensure stability and accuracy of measurements.

According to an aspect the present invention provides a wearable legwear system for detecting foot angles and distances, comprising:
i) a pair of socks, each sock having at least two sensors embedded within the sock material, wherein said sensors are configured to measure foot angles in three dimensions;
ii) a data transmission module integrated within each sock, wherein said data transmission module is configured to wirelessly transmit collected data from the sensors to an external processing unit;
iii) a rechargeable power source integrated within each sock to power the sensors and the data transmission module;
   wherein the sensors are strategically placed at the heel, midfoot, and optionally near the toes to provide optimal accuracy for foot angle and distance measurements;
   wherein the sensors comprise a combination of gyroscopes and accelerometers for accurate measurement of foot angles and movement;
   wherein the external processing unit is configured to receive the transmitted data and calculate the relative positioning and distance between the feet based on the data collected from both socks.

According to another aspect of the present invention there is provided a legwear article comprising:
i) a pair of socks, each sock having at least two sensors embedded within the sock material, wherein said sensors are configured to measure foot angles in three dimensions;
ii) a data transmission module integrated within each sock, wherein said data transmission module is configured to wirelessly transmit collected data from the sensors to an external processing unit;
iii) a rechargeable power source integrated within each sock to power the sensors and the data transmission module;
   wherein the sensors are strategically placed at the heel, midfoot, and optionally near the toes to provide optimal accuracy for foot angle and distance measurements;
   wherein the sensors comprise a combination of gyroscopes and accelerometers for accurate measurement of foot angles and movement;
   wherein the socks are made from a stretchy, breathable fabric to ensure user comfort during prolonged wear.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features and advantages of the embodiments of the present disclosure will be more apparent in the following description taken in conjunction with the accompanying drawings, in which:

FIG. 1 illustrates the placement of sensors and its schematic on the sensor-integrated sock. The sensors.

FIG. 2 is a block diagram showing the components of the sensor-integrated sock system and their interconnections.

FIG. 3 illustrates the user interface of the mobile application used to process and display the data collected by the sensor-integrated socks.

Persons skilled in the art will appreciate that elements in the figures are illustrated for simplicity and clarity and may not have been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRITION OF THE INVENTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

All terms (including technical and scientific terms) used herein have the same meaning as commonly understood by one of ordinary skill in the art to which various embodiments belong. Further, the meaning of terms or words used in the specification and the claims should not be limited to the literal or commonly employed sense but should be construed in accordance with the spirit of the disclosure to most properly describe the present disclosure.

The terminology used herein is for the purpose of describing particular various embodiments only and is not intended to be limiting of various embodiments. As used herein, the singular forms “a,” “an” and “the” are intended to include the plural forms as well, unless the context clearly indicates otherwise. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof.

The present disclosure will now be described more fully with reference to the accompanying drawings, in which various embodiments of the present disclosure are shown.

The present invention relates to a wearable legwear article, specifically a pair of sensor-integrated socks, designed to measure and monitor foot angles and distances in real-time. The invention aims to provide an accessible, user-friendly, and cost-effective solution for managing foot conditions such as Metatarsus adductus. The following detailed description outlines the components, functionality, and various embodiments of the invention.

### Components of the Invention

### Sensor-Integrated Socks

The socks are embedded with multiple sensors, including gyroscopes and accelerometers, strategically placed at key locations to ensure accurate measurement of foot angles and distances. The sensors are positioned as follows:
Heel Sensor (S1): Measures rearfoot orientation and stability.
Midfoot Sensor (S2): Tracks bending and central foot alignment.
Toe Sensor (S3): Optionally provides additional accuracy in monitoring forefoot positioning.

### Data Transmission Module

The sensors are connected to a Bluetooth module, enabling wireless transmission of collected data to an external processing unit, such as a mobile device. This module ensures real-time data streaming and seamless communication between the socks and the external device.

### Rechargeable Power Source

A lightweight, flexible rechargeable battery powers the sensors and Bluetooth module. The battery is integrated into the socks in a manner that does not interfere with user comfort or sensor accuracy. The battery can be recharged using standard charging methods.

### EMBODIMENTS OF THE INVENTION

### Embodiment 1: Basic Sensor-Integrated Socks

In this embodiment, the socks are equipped with the basic components described above: sensors, a Bluetooth module, and a rechargeable battery. The sensors measure foot angles in three dimensions (pitch, roll, and yaw) and detect the distance between the feet. The collected data is transmitted to a mobile device for real-time monitoring and analysis.

### Components

### 1. Sensor-Integrated Socks

The socks are designed using stretchy, breathable fabric to ensure user comfort during prolonged wear. The fabric is chosen for its flexibility and durability, allowing the sensors to function accurately without being affected by the movement of the foot.

### 2. Sensors

The socks are embedded with multiple sensors, including gyroscopes and accelerometers, strategically placed at key locations to ensure accurate measurement of foot angles and distances. The sensors are positioned as follows:
Heel Sensor (S1): Positioned near the heel to measure rearfoot orientation and stability. This sensor tracks the rotation and tilt of the heel, providing data on how the rearfoot is positioned.
Midfoot Sensor (S2): Positioned at the midfoot to track bending and central foot alignment. This sensor monitors the arch of the foot, detecting any deviations in the central alignment.
Toe Sensor (S3): Optionally positioned near the toes to provide additional accuracy in monitoring forefoot positioning. This sensor captures the movement and angle of the forefoot, enhancing the overall accuracy of the measurements.

### 3. Data Transmission Module

The sensors are connected to a Bluetooth module, enabling wireless transmission of collected data to an external processing unit, such as a mobile device. The Bluetooth module is compact and lightweight, ensuring it does not interfere with the comfort or functionality of the socks.

### 4. Rechargeable Power Source

A lightweight, flexible rechargeable battery powers the sensors and Bluetooth module. The battery is integrated into the socks in a manner that does not interfere with user comfort or sensor accuracy. The battery can be recharged using standard charging methods, such as a USB charger.

### Functionality

### 1. Foot Angle Measurement

The embedded sensors collect data related to foot orientation and movement in three dimensions. Using both gyroscope and accelerometer technology, the invention can accurately measure foot angles, including:
Pitch: The up and down tilt of the foot.
Roll: The side-to-side tilt of the foot.
Yaw: The rotation of the foot around its vertical axis.

The gyroscopes measure the angular velocity of the foot, while the accelerometers measure the linear acceleration. By combining the data from both types of sensors, the system can calculate the exact angles of the foot in real-time.

### 2. Distance Measurement

Using data from both socks, the relative positioning and distance between the feet can be calculated. This helps in determining whether the feet are positioned too far apart or too close, aiding in the detection of improper alignment. The system uses the coordinates of the sensors to calculate the distance between corresponding points on each foot.

### 3. Data Transmission

The collected data is transmitted wirelessly to an external processing unit, such as a mobile device, via the Bluetooth module. The real-time data transmission ensures that users receive immediate feedback on their foot positioning, allowing for prompt detection and correction of any issues.

### User Experience

### 1. Comfort and Design

The socks are designed for comfort and prolonged wear. The stretchy, breathable fabric ensures that the socks fit snugly without causing discomfort. The sensors and battery are integrated into the socks in a manner that does not interfere with the user's daily activities.

### 2. Ease of Use

The basic sensor-integrated socks are easy to use, requiring minimal setup. Users simply need to wear the socks and pair them with the external processing unit, such as a mobile device, to start receiving real-time data on their foot positioning.

### Embodiment 2: Enhanced Sensor Placement

This embodiment includes additional sensors placed near the toes (S3) to provide greater accuracy in monitoring forefoot positioning. The enhanced sensor placement ensures more precise measurements of foot angles and distances, particularly useful for detecting subtle deviations in foot alignment.

This embodiment is particularly useful for detecting subtle deviations in foot alignment and ensuring precise measurements, which are critical for managing foot conditions such as Metatarsus adductus.

### Components

### 1. Sensor-Integrated Socks

Similar to Embodiment 1, the socks are designed using stretchy, breathable fabric to ensure user comfort during prolonged wear. The fabric is chosen for its flexibility and durability, allowing the sensors to function accurately without being affected by the movement of the foot.

### 2. Enhanced Sensor Placement

In addition to the basic sensors positioned at the heel and midfoot, this embodiment includes an optional sensor near the toes to provide additional accuracy in monitoring forefoot positioning. The sensors are positioned as follows:
Heel Sensor (S1): Positioned near the heel to measure rearfoot orientation and stability. This sensor tracks the rotation and tilt of the heel, providing data on how the rearfoot is positioned.
Midfoot Sensor (S2): Positioned at the midfoot to track bending and central foot alignment. This sensor monitors the arch of the foot, detecting any deviations in the central alignment.
Toe Sensor (S3): Positioned near the toes to provide additional accuracy in monitoring forefoot positioning. This sensor captures the movement and angle of the forefoot, enhancing the overall accuracy of the measurements.

### 3. Data Transmission Module

The sensors are connected to a Bluetooth module, enabling wireless transmission of collected data to an external processing unit, such as a mobile device. The Bluetooth module is compact and lightweight, ensuring it does not interfere with the comfort or functionality of the socks.

### 4. Rechargeable Power Source

A lightweight, flexible rechargeable battery powers the sensors and Bluetooth module. The battery is integrated into the socks in a manner that does not interfere with user comfort or sensor accuracy. The battery can be recharged using standard charging methods, such as a USB charger.

### Functionality

### 1. Foot Angle Measurement

The embedded sensors collect data related to foot orientation and movement in three dimensions. Using both gyroscope and accelerometer technology, the invention can accurately measure foot angles, including:
Pitch: The up and down tilt of the foot.
Roll: The side-to-side tilt of the foot.
Yaw: The rotation of the foot around its vertical axis.

The gyroscopes measure the angular velocity of the foot, while the accelerometers measure the linear acceleration. By combining the data from all three sensors (heel, midfoot, and toe), the system can calculate the exact angles of the foot in real-time with enhanced accuracy.

### 2. Distance Measurement

Using data from both socks, the relative positioning and distance between the feet can be calculated. This helps in determining whether the feet are positioned too far apart or too close, aiding in the detection of improper alignment. The system uses the coordinates of the sensors to calculate the distance between corresponding points on each foot. The additional toe sensor provides more data points, improving the precision of the distance measurements.

### 3. Data Transmission

The collected data is transmitted wirelessly to an external processing unit, such as a mobile device, via the Bluetooth module. The real-time data transmission ensures that users receive immediate feedback on their foot positioning, allowing for prompt detection and correction of any issues.

### User Experience

### 1. Comfort and Design

The socks are designed for comfort and prolonged wear. The stretchy, breathable fabric ensures that the socks fit snugly without causing discomfort. The sensors and battery are integrated into the socks in a manner that does not interfere with the user's daily activities.

### 2. Ease of Use

The enhanced sensor-integrated socks are easy to use, requiring minimal setup. Users simply need to wear the socks and pair them with the external processing unit, such as a mobile device, to start receiving real-time data on their foot positioning.

### Embodiment 3: Mobile Application Integration

In this embodiment, the sensor-integrated socks are paired with a dedicated mobile application. The application processes and displays the collected data, providing users with real-time information on their foot positioning. The application supports multiple user profiles, stores historical data for trend analysis, and generates alerts when the measured foot angles or distances fall outside predefined thresholds.

This embodiment enhances the user experience by providing a comprehensive platform for processing, displaying, and analyzing the data collected by the sensors. The mobile application serves as the external processing unit, offering real-time feedback, historical data storage, and user-friendly features to assist in the management of foot conditions such as Metatarsus adductus.

### Components

### 1. Sensor-Integrated Socks

The socks are designed using stretchy, breathable fabric to ensure user comfort during prolonged wear. The fabric is chosen for its flexibility and durability, allowing the sensors to function accurately without being affected by the movement of the foot.

### 2. Sensors

The socks are embedded with multiple sensors, including gyroscopes and accelerometers, strategically placed at key locations to ensure accurate measurement of foot angles and distances. The sensors are positioned as follows:
Heel Sensor (S1): Positioned near the heel to measure rearfoot orientation and stability.
Midfoot Sensor (S2): Positioned at the midfoot to track bending and central foot alignment.
Toe Sensor (S3): Optionally positioned near the toes to provide additional accuracy in monitoring forefoot positioning.

### 3. Data Transmission Module

The sensors are connected to a Bluetooth module, enabling wireless transmission of collected data to the mobile application. The Bluetooth module is compact and lightweight, ensuring it does not interfere with the comfort or functionality of the socks.

### 4. Rechargeable Power Source

A lightweight, flexible rechargeable battery powers the sensors and Bluetooth module. The battery is integrated into the socks in a manner that does not interfere with user comfort or sensor accuracy. The battery can be recharged using standard charging methods, such as a USB charger.

### Mobile Application

### 1. Real-Time Data Processing

The mobile application receives data from the sensors in real-time via the Bluetooth module. The application processes the raw data from the gyroscopes and accelerometers to calculate foot angles and distances. The data is displayed in an intuitive and user-friendly interface, allowing users to monitor their foot positioning continuously.

### 2. User Profiles

The application supports multiple user profiles, allowing different individuals to use the same system. Each user can create a profile with personalized settings and thresholds for foot angles and distances. The application stores data separately for each user, ensuring accurate tracking and analysis.

### 3. Historical Data Storage

The application stores historical data for each user, enabling long-term monitoring and trend analysis. Users can view their foot positioning data over time, identify patterns, and track improvements or changes in their foot health. The historical data can be visualized through graphs and charts, making it easy to understand and analyze.

### 4. Alerts and Notifications

The application generates alerts when the measured foot angles or distances fall outside predefined thresholds. Users can set custom thresholds based on their specific needs and conditions. The alerts are designed to notify users of potential issues promptly, enabling early intervention and correction.

### 5. User Interface

The user interface of the mobile application is designed to be intuitive and easy to navigate. Key features of the interface include:
Real-Time Foot Angle Display: The current foot angles (pitch, roll, and yaw) are displayed in degrees.
Distance Measurement: The distance between the feet is displayed in centimeters or inches.
Graphs and Charts: Historical data is visualized through graphs and charts, showing trends and patterns over time.
Alerts and Notifications: Alerts are prominently displayed when thresholds are exceeded, with options for users to acknowledge and address the issues. The sensor-integrated socks, in conjunction with the dedicated mobile application, provide a robust alert and notification system designed to inform users of potential issues with their foot positioning in real-time. This system is crucial for early detection and intervention, particularly for managing conditions such as Metatarsus adductus.

### Logic for Alerts and Notifications

The alert and notification system operates based on predefined thresholds for foot angles and distances. These thresholds can be customized by the user based on their specific needs and conditions. The logic for generating alerts is as follows:
1. Data Collection: The sensors embedded in the socks continuously collect data on foot angles (pitch, roll, and yaw) and distances between the feet.
2. Data Transmission: The collected data is transmitted wirelessly to the mobile application via the Bluetooth module.
3. Data Processing: The mobile application processes the raw data to calculate the current foot angles and distances.
4. Threshold Comparison: The processed data is compared against the predefined thresholds set by the user.
5. Alert Generation: If the measured foot angles or distances fall outside the predefined thresholds, an alert is generated.
6. Notification Delivery: The alert is delivered to the user through the mobile application, which can include visual, auditory, and haptic notifications.

### Example of Alert Logic

Consider a user who has set the following thresholds for their foot angles:
Pitch: 0° to 15°
Roll: −10° to 10°
Yaw: −5° to 5°
Distance Between Feet: 5 cm to 15 cm

The logic for generating an alert can be represented as follows:

### Example Thresholds

min_pitch=0 max_pitch=15 min_roll=−10 max_roll=10 min_yaw=−5
max_yaw=5 min_distance=5 max_distance=15
   Function to Check if the Current Measurements are within Thresholds
def check_thresholds(pitch, roll, yaw, distance): if pitch<min_pitch or pitch>
max_pitch: send_alert(“Pitch angle out of range”) if roll<min_roll or roll>
max_roll: send_alert(“Roll angle out of range”) if yaw<min_yaw or yaw>
max_yaw: send_alert(“Yaw angle out of range”) if distance<min_distance or distance>max_distance: send_alert(“Distance between feet out of range”)

### Function to Send an Alert

def send_alert(message): #Code to send alert to the user via the mobile application print(f “Alert: {message}”)
   Example Data from Sensors
current_pitch=20 current_roll=5 current_yaw=−3 current_distance=12

### Check the Current Measurements Against the Thresholds

check_thresholds(current_pitch, current_roll, current_yaw, current_distance)

In this example, the current pitch angle is 20°, which is outside the predefined range of 0° to 15°. As a result, an alert is generated with the message “Pitch angle out of range.”

### Types of Notifications

The mobile application can deliver various types of notifications to inform the user of potential issues:
1. Visual Notifications: Pop-up messages or alerts displayed on the screen of the mobile device.
2. Auditory Notifications: Sound alerts or voice messages to notify the user of an issue.
3. Haptic Notifications: Vibration alerts to provide a tactile notification, particularly useful during physical activities.

### Example of Notification Delivery

When an alert is generated, the mobile application can deliver the notification as follows:

### Function to Send a Visual Notification

def send_visual_notification(message): #Code to display a pop-up message on the mobile device print(f “Visual Notification: {message}”)

### Function to Send an Auditory Notification

def send_auditory_notification(message): #Code to play a sound alert or voice message print(f “Auditory Notification: {message}”)

### Function to Send a Haptic Notification

def send_haptic_notification( ) #Code to trigger a vibration alert print (“Haptic Notification: Vibration Alert”)

### Example Alert Message

alert_message=“Pitch angle out of range”

### Deliver the Notification

send_visual_notification(alert_message)
send_auditory_notification(alert_message) send_haptic_notification( )

### Embodiment 4: Sports Mode

This embodiment includes a sports mode within the mobile application that adjusts thresholds based on the selected physical activity. For example, the thresholds for foot angles and distances may be relaxed during running or other static and/or dynamic movements. The sports mode also includes an option to mute notifications to avoid constant alerts during physical activity.

This mode is designed to adjust the monitoring thresholds based on the selected physical activity, providing more accurate and relevant feedback during static and/or dynamic movements. The sports mode enhances the versatility of the system, making it suitable for athletes and individuals engaged in various sports activities.

### Components

### 1. Sensor-Integrated Socks

The socks are designed using stretchy, breathable fabric to ensure user comfort during prolonged wear. The fabric is chosen for its flexibility and durability, allowing the sensors to function accurately without being affected by the movement of the foot.

### 2. Sensors

The socks are embedded with multiple sensors, including gyroscopes and accelerometers, strategically placed at key locations to ensure accurate measurement of foot angles and distances. The sensors are positioned as follows:
Heel Sensor (S1): Positioned near the heel to measure rearfoot orientation and stability.
Midfoot Sensor (S2): Positioned at the midfoot to track bending and central foot alignment.
Toe Sensor (S3): Optionally positioned near the toes to provide additional accuracy in monitoring forefoot positioning.

### 3. Data Transmission Module

The sensors are connected to a Bluetooth module, enabling wireless transmission of collected data to the mobile application. The Bluetooth module is compact and lightweight, ensuring it does not interfere with the comfort or functionality of the socks.

### 4. Rechargeable Power Source

A lightweight, flexible rechargeable battery powers the sensors and Bluetooth module. The battery is integrated into the socks in a manner that does not interfere with user comfort or sensor accuracy. The battery can be recharged using standard charging methods, such as a USB charger.

### Mobile Application

### 1. Real-Time Data Processing

The mobile application receives data from the sensors in real-time via the Bluetooth module. The application processes the raw data from the gyroscopes and accelerometers to calculate foot angles and distances. The data is displayed in an intuitive and user-friendly interface, allowing users to monitor their foot positioning continuously.

### 2. Sports Mode

The sports mode is a specialized feature within the mobile application that adjusts the monitoring thresholds based on the selected physical activity. This mode is designed to accommodate the static and/or dynamic movements associated with various sports, providing more accurate and relevant feedback. Key features of the sports mode include:
Activity Selection: Users can select from a list of sports activities, such as running, football, basketball, and more. Each activity has predefined thresholds for foot angles and distances that are tailored to the specific movements involved in the sport.
Threshold Adjustment: The application automatically adjusts the monitoring thresholds based on the selected activity. For example, during running, the thresholds for foot angles may be relaxed to account for the natural variations in foot positioning.
Real-Time Feedback: The application provides real-time feedback on foot positioning, helping users maintain proper alignment and avoid injuries during sports activities.

### 3. Mute Notifications

To avoid constant alerts during static and/or dynamic movements, the sports mode includes an option to mute notifications. Users can enable this feature to prevent interruptions while they are engaged in physical activities. The application will still collect and store data for later analysis, but it will not generate real-time alerts.

### 4. User Profiles

The application supports multiple user profiles, allowing different individuals to use the same system. Each user can create a profile with personalized settings and thresholds for foot angles and distances. The application stores data separately for each user, ensuring accurate tracking and analysis.

### 5. Historical Data Storage

The application stores historical data for each user, enabling long-term monitoring and trend analysis. Users can view their foot positioning data over time, identify patterns, and track improvements or changes in their foot health. The historical data can be visualized through graphs and charts, making it easy to understand and analyze.

### Technical Effect

The technical effect of the present invention includes:
Enhanced Accessibility: Users can monitor their foot positioning independently, without the need for frequent specialist visits.
Real-Time Data: Continuous, real-time monitoring allows for the early detection of potential issues, enabling timely intervention.
User Engagement: The mobile application engages users in their own health monitoring, promoting proactive management of foot conditions.
Cost-Effectiveness: By reducing the need for specialist consultations and clinical equipment, the invention offers a more affordable solution for managing foot health.

### FIGURES AND ILLUSTRATIONS

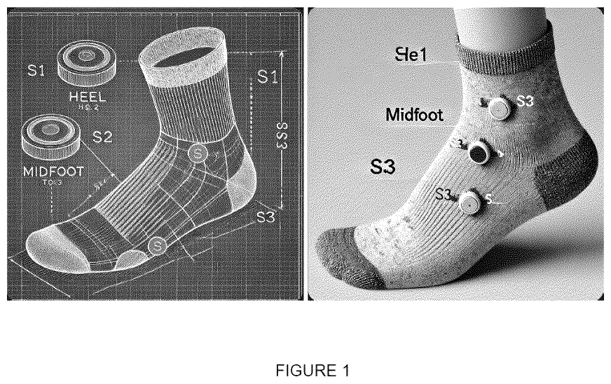

### FIG. 1: Overview of Sensor Placement in Socks

This figure illustrates the placement of sensors on the sensor-integrated sock. The sensors are labeled as follows:
Heel Sensor (S1)
L Midfoot Sensor (S2)
Toe Sensor (S3)

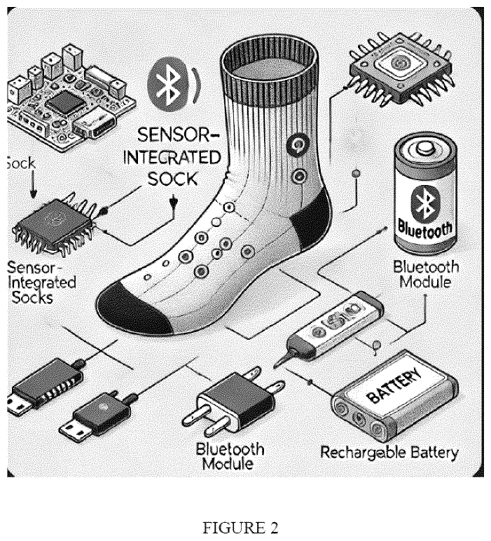

### FIG. 2: Detailed Schematic of Sensor Placement

This figure provides a detailed schematic of the sensor placement within the sock. The sensors are labeled and their positions are indicated:
Heel Sensor (S1)
Midfoot Sensor (S2)
Toe Sensor (S3)

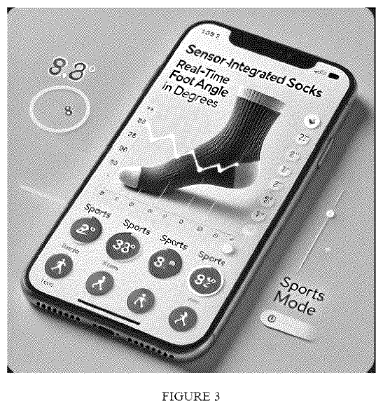

### FIG. 3: Block Diagram of Data Transmission System

This figure is a block diagram showing the components of the sensor-integrated sock system and their interconnections:
Sensor-Integrated Sock
Bluetooth Module
Rechargeable Battery

### FIG. 4: Mobile Application Interface

This figure illustrates the user interface of the mobile application used to process and display the data collected by the sensor-integrated socks:
Sensor-Integrated Socks (1)
Real-Time Foot Angle in Degrees (2)
Sports Mode (3)

By achieving these aspects and implementations, the present invention aims to improve the management of foot health, particularly for individuals at risk of developing conditions like Metatarsus adductus, and to enhance the overall user experience through innovative, wearable technology.

### Advantages of the Present Invention

The present invention offers several significant advantages over traditional methods for monitoring and managing foot conditions such as Metatarsus adductus. These advantages include:

### 1. Non-Invasive Real-Time Monitoring

Continuous Data Collection: The sensor-integrated socks provide continuous, real-time data on foot positioning, allowing for the early detection of potential issues.
Immediate Feedback: Users receive immediate feedback on their foot angles and distances, enabling prompt intervention and correction.

### 2. Enhanced Accessibility

Self-Monitoring: The invention allows individuals to monitor their foot health independently, without the need for frequent specialist visits or clinical settings.
User-Friendly Application: The dedicated mobile application is intuitive and easy to use, making it accessible to a wide range of users, including young children, athletes, and those undergoing physical therapy.

### 3. Accurate Measurement

Advanced Sensors: The integration of gyroscope and accelerometer sensors ensures high accuracy in detecting three-dimensional foot angles and positioning.
Enhanced Sensor Placement: The strategic placement of sensors at the heel, midfoot, and optionally near the toes provides optimal accuracy for foot angle and distance measurements.

### 4. Portable and Comfortable Design

Stretchy, Breathable Fabric: The socks are made from stretchy, breathable fabric, ensuring user comfort during prolonged wear.
Lightweight Components: The sensors, Bluetooth module, and rechargeable battery are lightweight and flexible, making the socks suitable for daily use.

### 5. Cost-Effectiveness

Reduced Need for Specialist Consultations: By enabling self-monitoring, the invention reduces the need for frequent specialist consultations, lowering healthcare costs for users.
Affordable Solution: The sensor-integrated socks offer a more affordable alternative to traditional methods that require clinical equipment and specialist intervention.

### 6. Versatility

Sports Mode: The sports mode within the mobile application adjusts thresholds based on the selected physical activity, providing more accurate and relevant feedback during static and/or dynamic movements.
Multiple User Profiles: The application supports multiple user profiles, allowing different individuals to use the same system with personalized settings and thresholds.

### 7. Historical Data Analysis

Long-Term Monitoring: The application stores historical data for each user, enabling long-term monitoring and trend analysis.
Visual Data Representation: Historical data is visualized through graphs and charts, making it easy for users to understand and analyze their foot health over time.

### 8. Customizable Alerts and Notifications

Threshold-Based Alerts: The application generates alerts when the measured foot angles or distances fall outside predefined thresholds, enabling early intervention.
Customizable Settings: Users can set custom thresholds based on their specific needs and conditions, ensuring personalized monitoring.

### 9. User Engagement

Proactive Health Management: The real-time feedback and customizable settings engage users in their own health monitoring, promoting proactive management of foot conditions.
Educational Value: The application provides valuable insights into foot health, helping users understand the importance of proper foot positioning and alignment.

### 10. Technical Effect

Enhanced Accuracy: The combination of advanced sensors and strategic placement ensures precise measurements of foot angles and distances.
Real-Time Data Transmission: The Bluetooth module enables seamless, real-time data transmission to the mobile application, ensuring immediate feedback and monitoring.

By offering these advantages, the present invention provides a comprehensive, user-friendly, and cost-effective solution for monitoring and managing foot health. The sensor-integrated socks and dedicated mobile application enhance the overall user experience, making it easier for individuals to detect and address foot positioning issues promptly, ultimately improving outcomes for patients and reducing healthcare costs.

The descriptions and illustrations provided in this document are intended to explain the principles of the invention and its best mode of working. They are not intended to limit the scope of the invention, which is defined by the claims. Variations and modifications to the described embodiments may be made without departing from the scope of the invention. The specific embodiments described in this document are examples of the invention and are not intended to limit the scope of the claims.

The claims should be interpreted broadly to cover all equivalent structures and methods that fall within the scope of the invention. The technical specifications and details provided in this document are for illustrative purposes only. Actual implementations of the invention may vary based on specific design requirements, manufacturing processes, and application needs.

Any references to prior art documents, patents, or publications are provided for informational purposes only. The inclusion of such references does not imply that the present invention is limited by or dependent on the prior art.

The inventors and assignees reserve the right to make modifications, improvements, and updates to the invention described in this document. Such modifications and improvements may be made without notice and may not be reflected in this document.

We claim:

1. A wearable legwear system for detecting foot angles and distances, comprising:
i) a pair of socks, each sock having at least two sensors embedded within the sock material, wherein said sensors are configured to measure foot angles in three dimensions;
ii) a data transmission module integrated within each sock, wherein said data transmission module is configured to wirelessly transmit collected data from the sensors to an external processing unit;
iii) a rechargeable power source integrated within each sock to power the sensors and the data transmission module;
wherein the sensors are strategically placed at the heel, midfoot, and optionally near the toes to provide optimal accuracy for foot angle and distance measurements;
wherein the sensors comprise a combination of gyroscopes and accelerometers for accurate measurement of foot angles and movement;
wherein the external processing unit is configured to receive the transmitted data and calculate the relative positioning and distance between the feet based on the data collected from both socks.

2. The legwear system of claim 1, wherein the data transmission module is a Bluetooth module.

3. The legwear system of claim 1, wherein the sensors are integrated into pockets within the sock material to ensure stability and accuracy of measurements.

4. The legwear system of claim 1, wherein the rechargeable power source is a lightweight, flexible battery such as a lithium polymer (LiPo) battery.

5. The legwear system of claim 1, wherein the external processing unit is a mobile device running a dedicated application for processing and displaying the collected data.

6. The legwear system of claim 1, wherein the sensors are configured to measure foot angles including pitch, roll, and yaw.

7. The legwear system of claim 1, wherein the external processing unit is further configured to generate alerts when the measured foot angles or distances fall outside predefined thresholds.

8. The legwear system of claim 1, wherein the sensors are configured to provide real-time data streaming to the external processing unit.

9. The legwear system of claim 1, wherein the external processing unit is configured to store historical data for trend analysis and long-term monitoring of foot positioning.

10. The legwear system of claim 1, wherein the socks are made from a stretchy, breathable fabric to ensure user comfort during prolonged wear.

11. The legwear system of claim 1, wherein the external processing unit is configured to support multiple user profiles, allowing different individuals to use the same system.

12. The legwear system of claim 1, wherein the external processing unit includes a graphical user interface that displays the current foot angles and distances in a user-friendly manner.

13. The legwear system of claim 1, wherein the sensors are calibrated to ensure accurate measurements of foot angles and distances.

14. The legwear system of claim 1, wherein the external processing unit is configured to provide a sports mode that adjusts the thresholds for foot angles and distances based on the selected physical activity.

15. The legwear system of claim 1, wherein the external processing unit is configured to mute notifications during active sports to avoid constant alerts during static and/or dynamic movements.

16. The legwear system of claim 1, wherein the external processing unit is configured to log the collected data for future analysis and potential integration with machine learning models to improve detection accuracy.

17. A legwear article comprising:
i) a pair of socks, each sock having at least two sensors embedded within the sock material, wherein said sensors are configured to measure foot angles in three dimensions;
ii) a data transmission module integrated within each sock, wherein said data transmission module is configured to wirelessly transmit collected data from the sensors to an external processing unit;
iii) a rechargeable power source integrated within each sock to power the sensors and the data transmission module;
wherein the sensors are strategically placed at the heel, midfoot, and optionally near the toes to provide optimal accuracy for foot angle and distance measurements;
wherein the sensors comprise a combination of gyroscopes and accelerometers for accurate measurement of foot angles and movement;
wherein the socks are made from a stretchy, breathable fabric to ensure user comfort during prolonged wear.

18. The legwear article of claim 1, wherein the data transmission module is a Bluetooth module.

19. The legwear article of claim 1, wherein the sensors are integrated into pockets within the sock material to ensure stability and accuracy of measurements.

20. The legwear article of claim 1, wherein the rechargeable power source is a lightweight, flexible battery such as a lithium polymer (LiPo) battery.

21. The legwear article of claim 1, wherein the external processing unit is a mobile device running a dedicated application for processing and displaying the collected data.

22. The legwear article of claim 1, wherein the sensors are configured to measure foot angles including pitch, roll, and yaw.

23. The legwear article of claim 1, wherein the external processing unit is further configured to generate alerts when the measured foot angles or distances fall outside predefined thresholds.

24. The legwear article of claim 1, wherein the sensors are configured to provide real-time data streaming to the external processing unit.

25. The legwear article of claim 1, wherein the external processing unit is configured to store historical data for trend analysis and long-term monitoring of foot positioning.

26. The legwear article of claim 1, wherein the external processing unit is configured to support multiple user profiles, allowing different individuals to use the same system.

27. The legwear article of claim 1, wherein the external processing unit includes a graphical user interface that displays the current foot angles and distances in a user-friendly manner.

28. The legwear article of claim 1, wherein the sensors are calibrated to ensure accurate measurements of foot angles and distances.

29. The legwear article of claim 1, wherein the external processing unit is configured to provide a sports mode that adjusts the thresholds for foot angles and distances based on the selected physical activity.

30. The legwear article of claim 1, wherein the external processing unit is configured to mute notifications during active sports to avoid constant alerts during static and/or dynamic movements.

31. The legwear article of claim 1, wherein the external processing unit is configured to log the collected data for future analysis and potential integration with machine learning models to improve detection accuracy.

32. The legwear article of claim 1, wherein the socks are washable without damaging the embedded sensors, data transmission module, or rechargeable power source.

33. The legwear article of claim 1, wherein the sensors are configured to detect and measure the distance between the feet in addition to foot angles.

34. The legwear article of claim 1, wherein the external processing unit is configured to provide visual and auditory feedback to the user based on the collected data.

35. The legwear article of claim 1, wherein the sensors are configured to automatically calibrate upon initial use to ensure accurate measurements.

36. The legwear article of claim 1, wherein the socks include an indicator light to show the status of the sensors and the data transmission module.
